(19) United States
(12) Patent Application Publication
(10) Pub. No.: US 2006/0132474 A1
(43) Pub. Date: Jun. 22, 2006

(54) Power conserving display system

(75) Inventor: Siu H. Lam, Wood Cliff Lake, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: INTEL CORPORATION

(21) Appl. No.: 11/020,397

(22) Filed: Dec. 21, 2004

(51) Int. Cl. G09G 5/00

(52) U.S. Cl. 345/204

(57) ABSTRACT

Systems and methods of controlling a display provide for determining an operating mode of a mobile device, where the mobile device includes the display. An active region of the display and an inactive region of the display can be defined based on the operating mode. The active region enables user access to the device and the inactive region enables greater power savings.

### BACKGROUND

1. Technical Field

One or more embodiments of the present invention generally relate to display systems. More particularly, certain embodiments relate to deactivating regions of a display to reduce power consumption.

2. Discussion

Advances in electronics have enabled the proliferation of a wide variety of mobile electronic devices such as wireless phones, personal digital assistants, portable digital media players and notebook computing systems. Although significant advances in the field of micro-electronics have aided in the miniaturization and increased functionality of such devices, battery technology has struggled to provide smaller and more powerful mobile power sources. Accordingly, reducing the power consumption of mobile electronic devices has become important to device manufacturers as well as designers.

A particular difficulty relates to the fact that for many mobile devices, the demand for larger and brighter displays has led to the display becoming an increasing source of power drain. Certain power conservation techniques have involved the use of screen savers, which dim pixels of a display during periods of idleness. During these periods, however, the underlying electronics such as the display, display driver and display controller are typically maintained in an active state. As a result, the power saved by conventional screen saver techniques can be less than optimal. Further power conservation techniques for displays have involved turning off the display completely. Such approaches, however, can reduce or eliminate the user's ability to interact with the mobile device.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a diagram of an example of a display according to one embodiment of the invention;

FIGS. 2A-2D are diagrams of examples of mobile device displays according some embodiments of the invention;

FIG. 3 is a block diagram of an example of a system according to one embodiment of the invention;

FIG. 4 is a signaling diagram of an example of display control data;

FIG. 5 is a signaling diagram of an example of display control data according to one embodiment of the invention;

FIG. 6. is a flowchart of an example of a method of controlling a display according to one embodiment of the invention;

FIG. 7 is a flowchart of an example of a process of defining active and inactive regions of a display according to one embodiment of the invention; and

FIG. 8 is a flowchart of an example of a process of determining an operating mode of a mobile device according to one embodiment of the invention.

### DETAILED DESCRIPTION

In the following description, for purposes of explanation, numerous specific details are set forth in order to provide a thorough understanding of the embodiments of the present invention. It will be evident, however, to one skilled in the art that the embodiments of the present invention may be practiced without these specific details. In other instances, specific apparatus structures and methods have not been described so as not to obscure the embodiments of the present invention. The following description and drawings are illustrative of the embodiments of the invention and are not to be construed as limiting the embodiments of the invention.

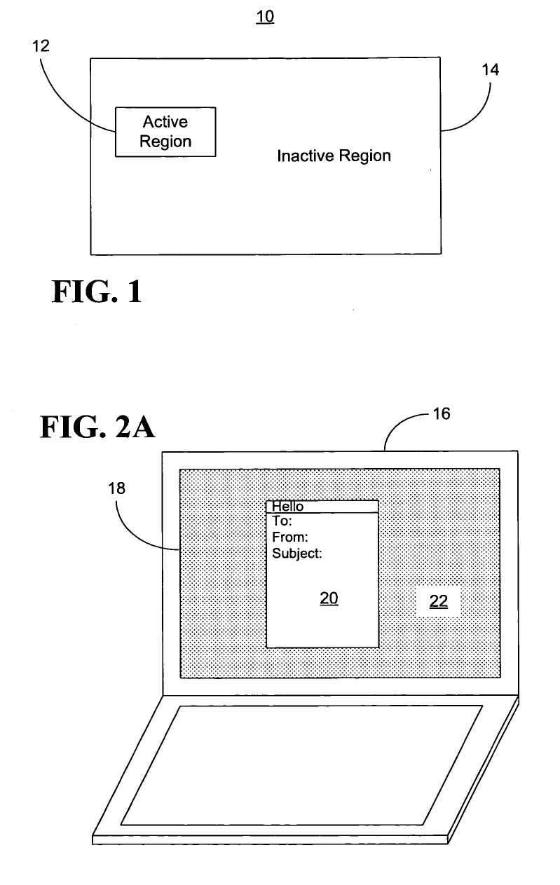

FIG. 1 shows a display 10, which in one embodiment is part of a mobile device such as a notebook computing system, personal digital assistant (PDA), wireless phone, and so on. The display 10 could be a liquid crystal display (LCD), an organic light-emitting diode (OLED) display, an electroluminescent (EL) display, plasma display, etc., and is shown as having an active region 12 and an inactive region 14. The active region 12 enables a user to interact with the device, while the inactive region 14 enables enhanced power savings for the display 10. For example, a user could check email or browse the Internet via the active region 12, although the electronics underlying the inactive region 14 may be powered down. By providing simultaneous accessibility and power reduction, the illustrated display 10 represents a substantial improvement over conventional displays.

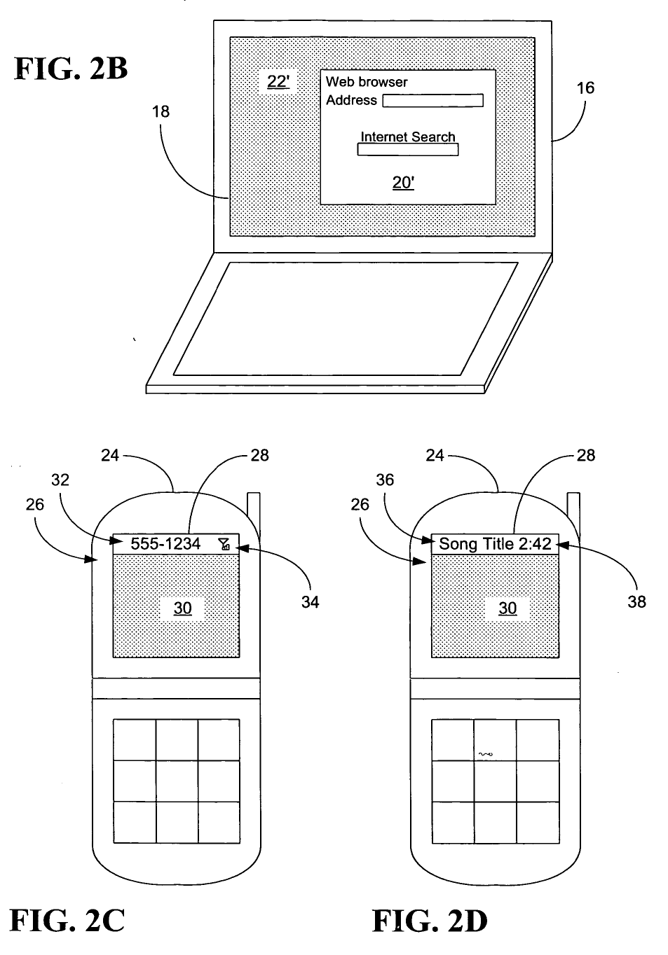

FIGS. 2A-2D demonstrate various scenarios in which a display such as the above-described display can be used. For example, FIG. 2A shows a notebook computing system 16 having a display 18 with an active region 20 and an inactive region 22. In the illustrated example, the notebook computing system 16 is in an email mode in which the active region 20 is associated with email window data. Thus, the user may compose, read, reply to and forward emails on the notebook computing system 16, while a significant portion of the display 18 is turned off. FIG. 2B shows an alternative embodiment in which the notebook computing system 16 is in a web browsing mode and the active region 20′ is associated with browser window data. The inactive region 22′, however, is powered down and provides substantial power savings for the display 18 and notebook computing system 16.

As will be discussed in greater detail, the various modes can be set and/or detected in a number of ways. For example, the window data that is associated with the active region could be selected affirmatively by the user or stored as a system policy. An example of a system policy might be one that detects when user input has not been received for a predetermined amount of time and deactivates the entire display screen except for the portion corresponding to the window/feature that was most recently selected. Such an “idleness” period would therefore enable the operating mode to be determined based on the most recently accessed window. Another example could be a system policy that tracks the user's activity and detects when the activity has been limited to a single window/feature for an extended amount of time. When such a “focused activity” period expires, the portion of the display screen lying outside the currently active window can be deactivated to save power. Yet another example of a mode selection technique would be to trigger the partial screen deactivation in response to a user request.

Turning now to FIG. 2C, another example is shown in which a wireless phone 24 has a display 26 with an active region 28 and an inactive region 30. In the illustrated example, the wireless phone 24 is in a wireless phone mode in which the active region 28 is associated with video data such as telephone number data 32, signal strength data 34, battery strength data (not shown) and so on. FIG. 2D shows an alternative embodiment in which the wireless phone is in a music player mode, where the active region 28 is associated with video data such as song title data 36 and/or song status data 38.

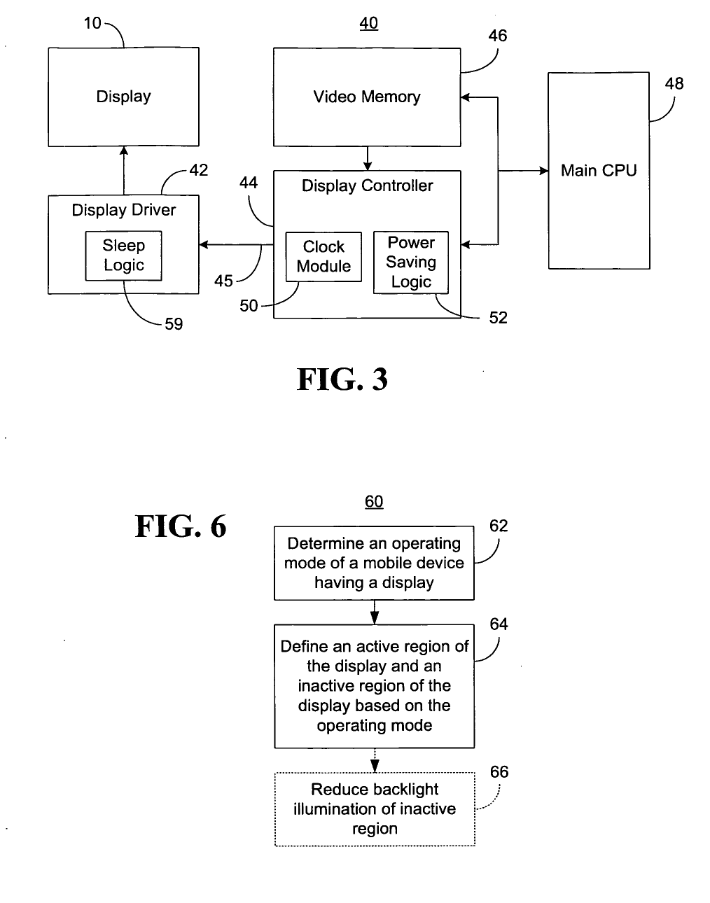

FIG. 3 shows a system 40 having a display 10, a driver 42 coupled to the display 10 and a display controller 44 coupled to the driver 42. In general, the display controller 44 may generate video interface signals 45, which contain both control data and video data. The driver 42 uses the video interface signals 45 to produce the desired visual output on the display 10. The illustrated system 40 also includes a video memory 46 and main central processing unit (CPU) 48 coupled to the display controller 44. The term “coupled” is used herein to any type of connection, direct or indirect, that enables communication across the interface in question. The video data and/or control data can be stored by the video memory 46 and processed by the CPU 48.

The system 40 could be part of a mobile device such as a notebook computing system 16 (FIGS. 2A and 2B), a wireless phone 24 (FIGS. 2C and 2D), a PDA (not shown), a media player (not shown), and so on. The illustrated display controller 44 is able to determine an operating mode of the device associated with the system 40 and define an active region of the display 10 based on the operating mode. As already discussed, the active region enables a user to interact with the device to accomplish various tasks. The display controller 44 can also define an inactive region of the display 10 based on the operating mode. The inactive region enables the system 40 to conserve more power than achievable in conventional systems.

In particular, the illustrated display controller 44 includes a clock module 50, where the clock module generates a video clock. The video clock is used by the driver 42 to clock in pixel data contained in the video data. Power saving logic 52 is configured to apply the video clock to the driver 42 for a first portion of each video frame to define the active region of the display 10 and deactivate the video clock for a second portion of the video frames to define the inactive region of the display 10.

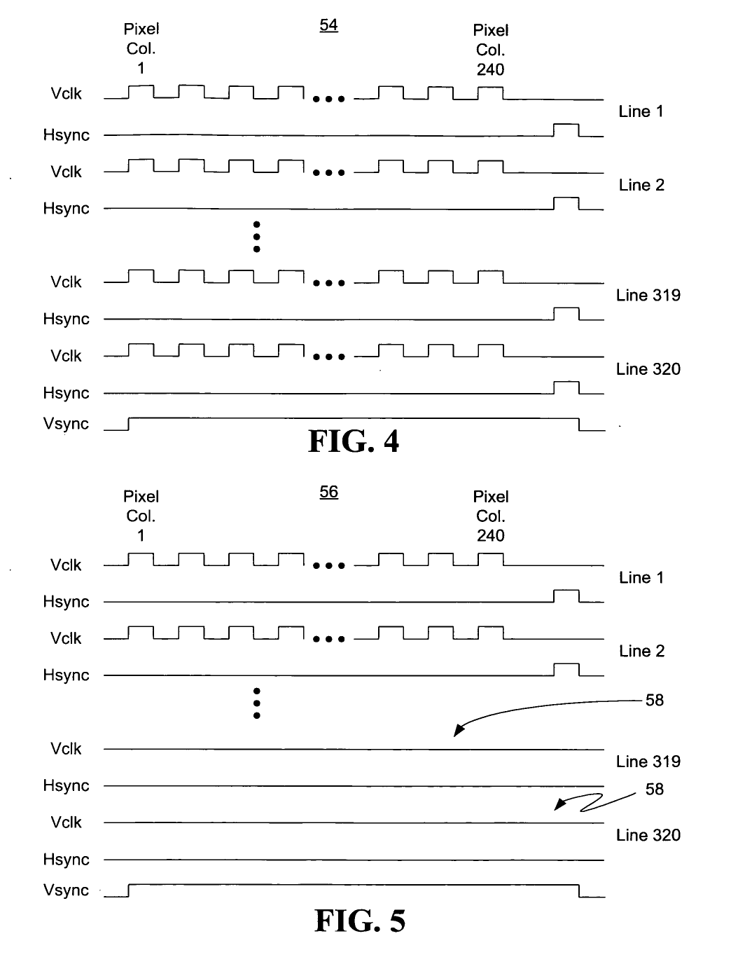

Turning now to FIGS. 4 and 5, one approach to defining active and inactive regions will be described in greater detail. In particular, FIG. 4 demonstrates control data 54 as it would be constructed for a conventional video frame (video data not shown). It can be seen that the video frame has a plurality of pixel lines (lines 1-320) and a plurality of pixel columns (columns 1-240). The control data 54 therefore establishes a display screen having 240×320 pixel resolution. The video clock (Vclk) is used to clock in each pixel of the video data. The horizontal sync (Hsync) is used to notify the driver 42 (FIG. 3) of a new video line, and the vertical sync (Vsync) is used to notify the driver 42 (FIG. 3) of a new video frame.

FIG. 5 illustrates control data 56 as it can be constructed for a video frame to define active and inactive regions. The control data 56 may be repeated for each video frame as appropriate, where the frame refresh rate can be set high enough to prevent the observer from noticing any flicker. In one example, the refresh rate is set at a value above 60 Hz. Generally, the video clock is deactivated at portions 58 of the video frame to define the inactive region, where the inactive region is located in the lower area of the display 10 (FIG. 3) in the example shown. Thus, the example demonstrated by control data 56 might correspond to the wireless phone display 26 (FIGS. 2C and 2D), discussed above. In particular, the illustrated video clock is powered down for a subset of the plurality of pixel lines that includes lines 319 and 320. This technique therefore defines a vertical component of the inactive region. Indeed, by powering down the video clock for pixel lines 33-320, a shutdown of ninety percent of the display screen can be achieved. Similarly, the video clock could be powered down for a subset of the pixel columns in order to define a horizontal component of the inactive region. For example, pixel positions 25-240 of each line could be de-clocked to define the right-most ninety percent of the display as the inactive region.

Returning now to FIG. 3, it can be seen that the driver 42 can include sleep logic 59 to power down the driver 42 and the display 10 if the video clock is deactivated. The sleep logic 59 therefore determines the active display region by the time during which the video clock is active with respect to the video control signals. The controller 44 is also able to power itself down if the video clock is deactivated to maximize the potential power savings. The display 10, driver 42 and controller 44 can each be powered up and down as needed to establish the active and inactive regions of each video frame.

If the display 10 is an LCD having a backlight, the backlight illumination of the inactive region can also be reduced. For example, the LCD could be provided with a first backlight designed to illuminate the entire display and a second backlight designed to illuminate a predetermined active region only (e.g., the top thirty-two lines of the display). When the display 10 enters the partial display state, the first backlight could be switched off and the second backlight could be switched on. When the display 10 returns to the full screen state, the first backlight could be switched on and the second backlight cold be switched off. Alternatively, the backlight could be modularized to provide more flexible backlighting schemes.

FIG. 6 shows a method 60 of controlling a display. The method 60 can be implemented in fixed functionality hardware such as complementary metal oxide semiconductor (CMOS) technology, microcode, software such as part of an operating system (OS), or any combination thereof. Processing block 62 provides for determining an operating mode of a mobile device having a display. An active region of the display and an inactive region of the display are defined at block 64 based on the operating mode. Block 66 provides for reducing the backlight illumination of the inactive region if appropriate.

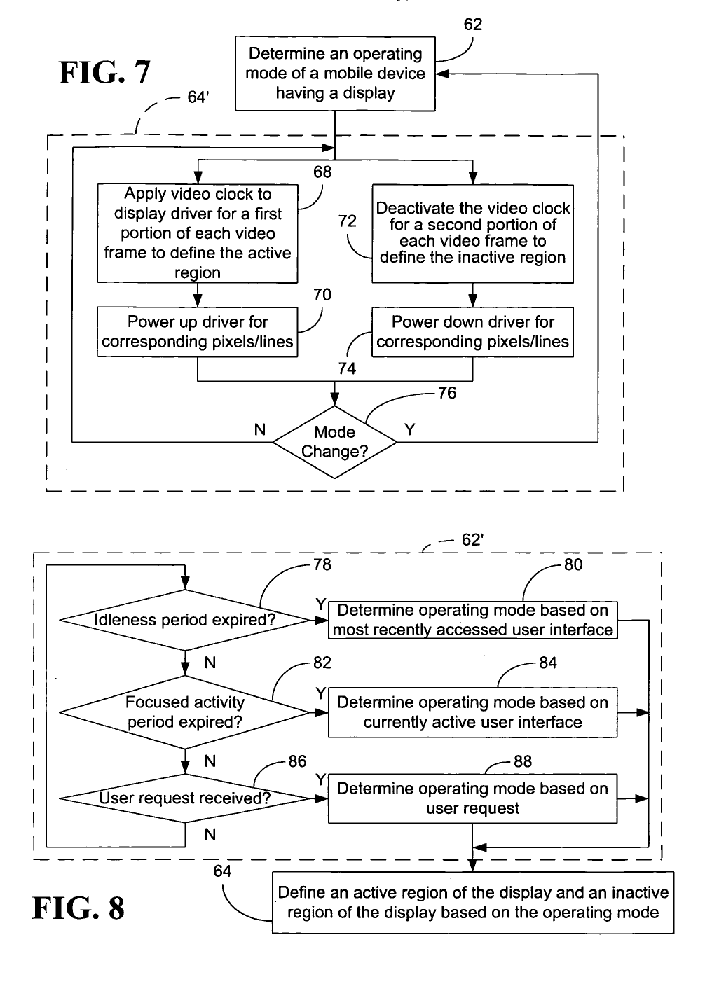

Turning now to FIG. 7, one approach to defining an active region and an inactive region of a display is shown in greater detail at block 64′. In particular, a video clock is applied to a driver of the display at block 68 for a first portion of a video frame to define the active region. Block 70 provides for powering up the driver, display and controller while the video clock is active. The video clock is deactivated at block 72 for a second portion of the video frame to define the inactive region. Block 74 provides for powering down the driver, display and controller while the video clock is deactivated. If it is determined at block 76 that a mode change has not occurred, the applying and deactivating are repeated for the next video frame. If a mode change has occurred, the new operating mode of the device is determined at block 62.

FIG. 8 shows one approach to determining an operating mode of a device in greater detail at block 62′. In particular, block 78 provides for determining whether an idleness period has expired. To make the determination at block 78, user input can be tracked by running a counter/timer whenever input is not being received from the user. When the counter reaches the value of the idleness period, block 80 can provide for identifying the operating mode based on the most recently accessed window/user interface. For example, the most recently accessed window could be associated with web browser data. In such a case, it could be determined that the device is in a web browser mode and the portion of the display falling outside the web browser window may be shut down.

Block 82 provides for determining whether a focused activity period has expired, where the term “focused activity” refers to a condition in which the user's interaction with the device is limited to a particular window or application. If so, the operating mode of the device is identified at block 84 based on the currently active window/user interface. For example, the user could be spending a significant amount of time composing an email. In such a case, it could be determined that the device is in an email mode and the portion of the display falling outside the email composing window may be shut down.

It may also be determined at block 86 whether a user request has been received. A user request could be an affirmative command to place the display in the partial shutdown state. The command/request may be a function command, part of an application interface, etc. If the user request is detected, block 88 provides for determining the operating mode based on the user request. For example, the user could select a particular window and enter a command to shut down the portion of the display falling outside the selected window. The display controller could then construct the control data accordingly.

A significant portion of the above techniques can be implemented in display controller software, and therefore provide a power conservation approach that does not require costly controller and/or display modifications. The overall power savings can be significant since the display subsystem may use a large portion of the power budget, particularly in view of recent trends toward larger and brighter displays. These advantages are particularly useful for mobile devices, which have tight power and temperature constraints.

Those skilled in the art can appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A method comprising:
determining an operating mode of a mobile device having a display;
defining an active region of the display and an inactive region of the display based on the operating mode.

2. The method of claim 1, wherein the defining includes:
applying a video clock from a controller to a driver of the display for a first portion of a video frame to define the active region; and
deactivating the video clock for a second portion of the video frame to define the inactive region.

3. The method of claim 2, wherein the video frame includes a plurality of pixel lines and a plurality of pixel columns, the deactivating including powering down the video clock for a subset of the plurality of pixel lines to define a vertical component of the inactive region and powering down the video clock for a subset of the plurality of pixel columns to define a horizontal component of the inactive region.

4. The method of claim 2, further including powering down the controller, the driver and the display for the second portion of the video frame.

5. The method of claim 2, further including repeating the applying and deactivating for a plurality of video frames.

6. The method of claim 1, further including reducing a backlight illumination of the inactive region of the display.

7. The method of claim 1, wherein the determining includes:
determining whether an idleness period has expired;
identifying the operating mode based on a most recently accessed user interface if the idleness period has expired;
determining whether a focused activity period has expired;
identifying the operating mode based on a currently active user interface if the focused activity period has expired;
determining whether a user request has been received; and
identifying the operating mode based on the user request if the user request has been received.

8. The method of claim 7, wherein determining the operating mode further includes determining that the mobile device is in a wireless phone mode, the active region corresponding to video data selected from a group comprising signal strength data, battery strength data and telephone number data.

9. The method of claim 7, wherein the determining includes determining that the mobile device is in a music player mode, the active region corresponding to video data selected from a group comprising song title data and song status data.

10. The method of claim 7, wherein the determining includes determining that the mobile device is in an email mode, the active region corresponding to email window data.

11. The method of claim 7, wherein the determining includes determining that the mobile device is in a web browsing mode, the active region corresponding to browser window data.

12. An apparatus comprising:
a display controller to determine an operating mode of a mobile device having a display and to define an active region of the display and an inactive region of the display based on the operating mode.

13. The apparatus of claim 12, wherein the display controller includes:
a clock module generate a video clock; and
power saving logic to apply the video clock to a driver of the display for a first portion of a video frame to define the active region and deactivate the video clock for a second portion of the video frame to define the inactive region.

14. The apparatus of claim 13, wherein the video frame is to include a plurality of pixel lines and a plurality of pixel columns, the power saving logic to power down the video clock for a subset of the plurality of pixel lines to define a vertical component of the inactive region and power down the video clock for a subset of the plurality of pixel columns to define a horizontal component of the inactive region.

15. The apparatus of claim 13, wherein the power saving logic is to apply the video clock and deactivate the video clock for a plurality of video frames.

16. The apparatus of claim 12, wherein the display controller is to determine whether an idleness period has expired, identify the operating mode based on a most recently accessed user interface if the idleness period has expired, determine whether a focused activity period has expired, identify the operating mode based on a currently active user interface if the focused activity period has expired, determine whether a user request has been received and identify the operating mode based on the user request if the user request has been received.

17. The apparatus of claim 16, wherein the display controller is to determine that the mobile device is in a mode selected from a group comprising a wireless phone mode, a music player mode, an email mode and a web browsing mode.

18. A system comprising:
a liquid crystal display;
a driver coupled to the display; and
a display controller coupled to the driver, the controller to determine an operating mode of a mobile device and define an active region of the display and an inactive region of the display based on the operating mode.

19. The system of claim 18, wherein the display controller includes:
a clock module generate a video clock; and
power saving logic to apply the video clock to the driver for a first portion of a video frame to define the active region and deactivate the video clock for a second portion of the video frame to define the inactive region.

20. The system of claim 19, wherein the video frame is to include a plurality of pixel lines and a plurality of pixel columns, the power saving logic to power down the video clock for a subset of the plurality of pixel lines to define a vertical component of the inactive region and power down the video clock for a subset of the plurality of pixel columns to define a horizontal component of the inactive region.

21. The system of claim 19, wherein the driver includes sleep logic to power down the driver and the display for the second portion of the video frame, the display controller to power itself down if the video clock is deactivated.

22. The system of claim 19, wherein the power saving logic is to apply the video clock and deactivate the video clock for a plurality of video frames.

23. The system of claim 18, wherein the display controller is to determine whether an idleness period has expired, identify the operating mode based on a most recently accessed user interface if the idleness period has expired, determine whether a focused activity period has expired, identify the operating mode based on a currently active user interface if the focused activity period has expired, determine whether a user request has been received and identify the operating mode based on the user request if the user request has been received.

24. The system of claim 23, wherein the operating mode includes a mode selected from a group comprising a wireless phone mode, a music player mode, an email mode and a web browsing mode.

25. A method comprising:
determining that a mobile device having a display is in an operating mode that is selected from a group comprising a wireless phone mode, a music player mode, an email mode and a web browsing mode;
applying a video clock to a driver of the display for a first portion of one or more video frames to define an active region of the display based on the operating mode;
deactivating the video clock for a second portion of each video frame to define an inactive region of the display based on the operating mode;
powering down the driver if the video clock is deactivated; and
reducing a backlight illumination of the inactive region of the display.

26. The method of claim 25, wherein the video frame includes a plurality of pixel lines, the deactivating including powering down the video clock for a subset of the plurality of pixel lines to define a vertical component of the inactive region.

27. The method of claim 25, wherein the video frame includes a plurality of pixel columns, the deactivating including powering down the video clock for a subset of the plurality of pixel columns to define a horizontal component of the inactive region.

28. A machine readable medium comprising a stored set of instructions, which upon execution are operable to:
determine an operating mode of a mobile device having a display; and
define an active region of the display and an inactive region of the display based on the operating mode.

29. The medium of claim 28, wherein the instructions are further operable to:
apply a video clock to a driver of the display for a first portion of a video frame to define the active region; and
deactivate the video clock for a second portion of the video frame to define the inactive region.

30. The medium of claim 29, wherein the video frame is to include a plurality of pixel lines, the instructions being operable to power down the video clock for a subset of the plurality of pixel lines to define a vertical component of the inactive region.

31. The medium of claim 29, wherein the video frame is to include a plurality of pixel columns, the instructions being operable to power down the video clock for a subset of the pixel columns to define a horizontal component of the inactive region.
